(19) United States
(12) Patent Application Publication
(10) Pub. No.: US 2012/0306644 A1
(43) Pub. Date: Dec. 6, 2012

(54) Fish Identification Device and Method of Use

(76) Inventor: Thomas Campbell, Melbourne, FL (US)

(21) Appl. No.: 13/153,859

(22) Filed: Jun. 6, 2011

(51) Int. Cl. H04N 5/225; G06K 9/00

(52) U.S. Cl. 340/539.13; 382/110; 348/207.1; 348/E05.024

(57) ABSTRACT

A fish identification device comprising a housing; a touchscreen on a front surface of the housing, where the touchscreen enables a user to view and operate a plurality of functions; an internal processor, where the internal processor operates a software; an internal GPS within the housing, where the internal GPS, functioning with the processor, informs the user of a set of fishing regulations pertaining to a location of the housing; a camera within the housing, where the camera includes a camera lens and a flash attached to a back surface of the housing and where said camera enables the user to photograph a fish; an internal memory, where the internal memory saves a plurality of information compiled during use; and a means to upload the plurality of information to a computer, where the means to upload enables the user to save he plurality of information on the computer.

### BACKGROUND OF THE INVENTION

1. Field of the Invention

The present invention relates to a device that enables a user to determine the local fishing regulations, photograph a fish, identify the fish and then save the information on an internal memory for a later use.

2. Description of Related Art

Fishing is a sport enjoyed by a wide range of individuals, ranging in skill levels from novice fishermen enjoying a Sunday afternoon to professionals fishing for prizes in tournaments. Whether professional or amateur, all of the fishermen must abide by local and state regulations which help to conserve fish populations, preserve animal habitats, and maintain fishing experiences beneficial to all. The regulations often guide the persons as to the size limits, bag limits, and seasonal restriction in the areas where they are trying to fish. Additionally, these restrictions may be species determinant wherein at certain times of the year specific species are allowed for fishing rather than others.

Accordingly, the fishermen are required to research the areas where they will be fishing to ensure that they comply with the requisite laws. A problem commonly encountered is that the research is often time consuming, overwhelming and confusing. This is especially problematic if the user wishes to travel to a remote location or to more than one fishing source. A device to assist determining local regulations is U.S. Pat. No. 6,459,372 by Devin Branham et. al. discloses a hand-held computer for identifying hunting and fishing area and displaying controlling regulations pertaining thereto. The computer monitors a user's location and compares it to a database of fish and game regulations in the area to inform the user of the regulations of their current position.

When out in the field, fishermen may also wish to record information about the climate, location, lure and fish type and the like so they can use the information at on future fishing trips. Some people may write the relevant information in a notebook on site or simply try to remember the conditions when they return to their home where they may record the information on their computer or laptop. Regardless of the recordation method, the information is useful later to improve fishing skills and determine optimal fishing locations.

Recently, some devices have been developed to assist fisherman improve their fishing success. U.S. Pat. No. 6,222,449 by Ronald F. Twining discloses a remote fish logging unit as a recording device to record relevant information related to fishing conditions. The unit has sensors to detect environmental conditions, measuring physical data of the fish and input mechanisms for the user to enter notes. Finally, U.S. Pat. No. 7,669,369 by Kent G. Davidson discloses a fishing system wherein a lure captures the ambient conditions at the time a fish is caught. The lure sends the information to a handheld control unit that is also capable of recording location (via GPS), fish weight, water quality and a photo of the fish.

While these devices assist a user to determine their location's fishing regulations, and save relevant conditional information a user may desire an all-in-one unit rather than have to carry separate devices for each characteristic determination. Therefore, it would be beneficial in the art to provide a single device that combines multiple features like assisting a user to determine their local fishing regulations, photographing the fish caught and identifying the fish species. It would also be desirable in the art to provide a device that enables a user to upload the information compiled into a log for future reference.

### SUMMARY OF THE INVENTION

In view of the foregoing disadvantages inherent in the prior art, the general purpose of the present invention is to provide a fish identification device, configured to include all of the advantages of the prior art, and to overcome the drawbacks inherent therein.

Accordingly, an object of the present invention is to provide a device that assists a user to determine their local fishing regulations, photographs a fish to save on an internal memory, and allows the user to identify the fish by comparing the fish to an internal database of fish species.

Another object of the present invention is to provide a device that uploads the information compiled to a computer and save the information in a log for future reference.

Another object of the present invention is to provide a device that includes a touchscreen to allow the user to easily navigate the features of the device.

To achieve the above objects, in an aspect of the present invention, a fish identification device is disclosed comprising a housing; a touchscreen on a front surface of the housing, where the touchscreen enables a user to view and operate a plurality of functions; an internal processor, where the internal processor operates a software; an internal GPS within the housing, where the internal GPS, functioning with the processor, informs the user of a set of fishing regulations pertaining to a location of the housing; a camera within the housing, where the camera includes a camera lens and a flash attached to a back surface of the housing and where said camera enables the user to photograph a fish; an internal memory, where the internal memory saves a plurality of information compiled during use; and a means to upload the plurality of information to a computer, where the means to upload enables the user to save he plurality of information on the computer.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a fish identification device in accordance with an exemplary embodiment of the present invention; and

FIG. 2 depicts a backside view of a fish identification device in accordance with an exemplary embodiment of the present invention.

Like reference numerals refer to like parts throughout the description of several views of the drawings.

### DETAILED DESCRIPTION OF THE DRAWINGS

The present invention relates to a device that enables a user to determine the local fishing regulations, photograph a fish, identify the fish and then save the information on an internal memory for a later use. Accordingly, the present invention provides a fish identification device as a means to easily determine and record a fish species encountered while on a fishing trip. The fish identification device comprises a waterproof housing that includes a processor that functions with a GPS and camera. The GPS enables the user to determine their exact location while fishing and allows the user to download local fishing regulations. The camera allows the user to photograph the fish they catch and then determine the species by comparing the fish to fish on a database within the device. The fish identification device includes a touchscreen for visual clarity and easy navigation of the electronic features making the device accessible to both novice and experienced fishers alike.

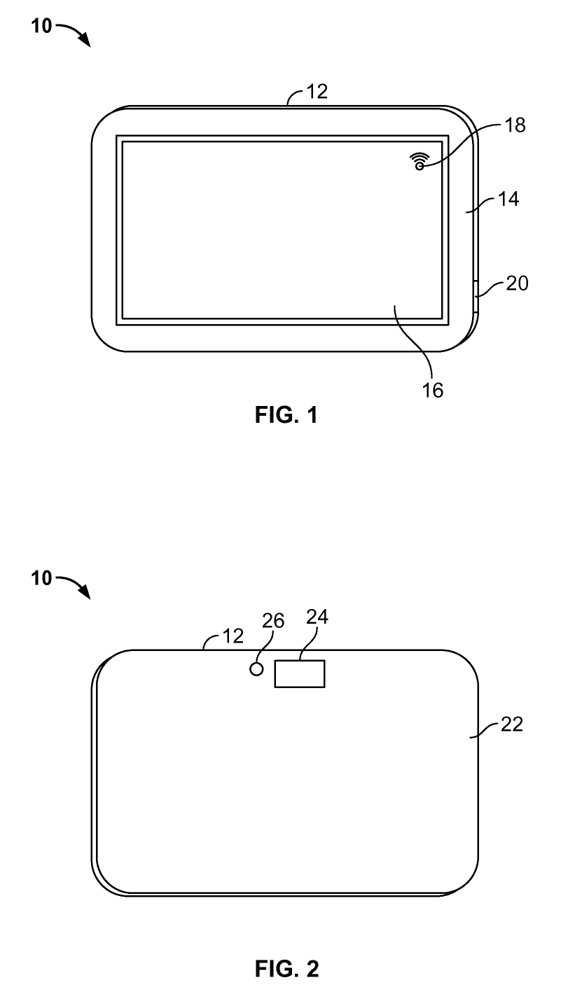

Tuning now descriptively to the drawings, referring to FIG. 1, a perspective view of a fish identification device (10) is shown in accordance with an exemplary embodiment of the present invention. The fish identification device (10) comprises a housing (12) as the body portion for the device. The housing (12) is a waterproof case that may be submerged in water without damage. With a small, compact size the housing (12) may be carried wherever desired for use and may be transported in a user's pocket, tackle box, bag and the like. Additionally, the housing (12) floats to prevent damage or loss during use in remote locations.

On a front surface (14) of the housing (12) is an LCD touchscreen (16). The touchscreen (16) allows the user to simply use their fingertips to maneuver through the plurality of functions while using the fish identification device (10). The touchscreen (16) may display images, photos, function windows, command buttons and the like to provide a visual stimulus for the user while operating the fish identification device (10).

On a peripheral portion of the touchscreen (16) may be a GPS (Global Positioning System) signal indicator (18). The GPS signal indicator (18) shines a small LED light to notify the user that an internal GPS is operating correctly and is performing at an optimal signal strength. The GPS signal indicator (18) may illuminate red or green light colors; a red light may indicate that the GPS signal is weak or nonexistent and a green light may indicate that the GPS signal is at or above the optimal strength.

Attached to a side portion of the housing (12) may be a USB outlet (20). The USB outlet (20) enables the fish identification device (10) to be connected to a computer using a USB cable. Within the housing (12) is an internal memory which compiles and stores information while using the fish identification device (10). When attached to the computer, the fish identification device (10) may upload information compiled by the internal memory into a database or log stored on the computer. This way the user is able to utilize the database to save and organize all the information received during each usage of the fish identification device (10). Alternatively, the housing (12) may include a Bluetooth device to enable the user to upload the information wirelessly.

Referring to FIG. 2, a backside view of the fish identification device (10) is shown in accordance with an exemplary embodiment of the present invention. On a back surface (22) of the housing (12) may be a camera lens (24) and a flash (26) the external embodiments of the camera feature of the fish identification device (10). The camera lens (24) and the flash (26) enable the user to take a photo of the fish and store it in the internal memory. The controls for taking a photo may be displayed on the touchscreen (16) on the front surface (14). Once the photo is taken the image is shown on the touchscreen (16) so that the user may either save the image or retake the photo.

The housing includes an internal processor that runs a specialized software specifically designed to operate the various functions of the fish identification device. The software is programmed to operate with the internal GPS, the camera and the computer. First, the software is compatible with the internal GPS by providing the user with fishing information that is location specific. By knowing the specific location of where the fish identification device is being used the most accurate the state and regional fishing regulations may be downloaded to inform the user of necessary information like bag limits, size limits, seasonal restrictions and the like.

Second, operating the processor with the camera, the photo of the fish may be stored and analyzed. A species recognition software may include a database of fish species against which the photos are analyzed to determine what type of fish the user has. The species recognition software may include categories for proper identification which allows the user to identify their fish species by body shapes, fin size, unique marking, specific colors, color patterns or a combination of all. After the fish is identified, the photo and information may be saved to the internal memory and then uploaded to the computer at a later time. The date, time, location and fish species may all be recorded and uploaded to the computer's memory thereby establishing a fishing log of all the catches and fishing trips experienced by the user. With the compilation information in the fishing log the user is able to go back and learn from their past trips to improve their future fishing experiences.

Accordingly, the fish identification device is simple to use, beneficial to both novice and experienced fishermen. First, the user may activate the device and determine the local fishing regulations by utilizing the internal GPS feature. Once the regulation information is determined the user may fish and go about their hunting activities as planned. After the user catches a fish they may photograph the fish with the camera and save the photo to the internal memory. Next, the user may continue fishing or try to determine the type of fish they caught. If they wish to identify the fish, they may compare the photo they took to the features and photos within the database of the fish recognition software. Using input features of the touchscreen, the user may add notes about the area, conditions encountered, equipment used, and any other factors the user may want to record or find useful at a future fishing trip. Once all of the information is compiled, it may be saved to the internal memory for later use. Finally, the compiled information may be uploaded to the computer and stored into the fishing log.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A fish identification device comprising:
a housing, where said housing is a waterproof case;
a touchscreen on a front surface of said housing, where said touchscreen enables a user to view and finger operate a plurality of functions associated with said fish identification device;
an internal processor, where said internal processor operates a software;
an internal GPS within said housing, where said internal GPS, functioning with said software, informs said user of a set of fishing regulations pertaining to a location of said housing;
a camera within said housing, where said camera includes a camera lens and a flash attached to a back surface of said housing and where said camera enables said user to photograph a fish caught while fishing;
an internal memory, where said internal memory saves a plurality of information compiled during use; and
a means to upload said plurality of information to a computer, where said means to upload enables said user to save said plurality of information on said computer.

2. The fish identification device according to claim 1, wherein said means to upload is a USB outlet positioned on a side of said housing to plug in a USB cable attached to said computer.

3. The fish identification device according to claim 1, wherein said means to upload is a Bluetooth device.

4. The fish identification device according to claim 1, wherein said software includes a database that includes information on a plurality of fish.

5. The fish identification device according to claim 4, wherein said database enables said user to compare said photograph of said fish to said plurality of fish on said database and then determine what type of fish they caught.

6. The fish identification device according to claim 5, wherein said internal memory saves said type of fish caught to upload to said computer.

7. The fish identification device according to claim 6, wherein said internal memory stores a date, a time and said type of fish to upload to a fishing log on said computer.

8. The fish identification device according to claim 1, wherein said touchscreen includes a GPS signal indicator to inform said user how said internal GPS is functioning.

9. The fish identification device according to claim 8, wherein said GPS signal indicator illuminates a red light when said internal GPS is receiving a weak signal and a green light when said internal GPS is operating at an optimal signal strength.

10. A method of use for a fish identification device comprising the steps of:
activating a housing of said fish identification device;
downloading fishing regulations utilizing a GPS and a processor within said housing;
taking a photograph of a fish with a camera within said housing;
displaying said photograph on a touchscreen; and
analyzing said fish against a database of fish operated by said processor to determine the fish species.

11. The method of using the fish identification device according to claim 10 further comprising the step of saving said photograph and said fish species on an internal memory and recording a date and time to create a compilation of data.

12. The method of using the fish identification device according to claim 11 further comprising the step of adding notes to said complication of data using said touchscreen.

13. The method of using the fish identification device according to claim 11 further comprising the step of uploading said compilation of data to a computer.

14. The method of using the fish identification device according to claim 12 further comprising the step of saving said compilation of data in a fishing log within said computer.
